(19) United States
(12) Patent Application Publication
(10) Pub. No.: US 2023/0126121 A1
(43) Pub. Date: Apr. 27, 2023

(54) BRAKING SYSTEM WITH REDUNDANT PARKING BRAKE ACTUATION

(71) Applicant: Continental Automotive Technologies GmbH, Hannover (DE)

(72) Inventors: Martin Brenn, Mainz (DE); Thorsten Ullrich, Gernsheim (DE)

(73) Assignee: Continental Automotive Technologies GmbH, Hannover (DE)

(21) Appl. No.: 17/905,507

(22) PCT Filed: Mar. 1, 2021
(86) PCT No.: PCT/DE2021/200026

§ 371 Date: Sep. 2, 2022

(30) Foreign Application Priority Data
Mar. 6, 2020 (DE) 10 2020 202 919.9

(51) Int. Cl. B60T 8/88; B60T 13/74; B60T 17/22

(52) U.S. Cl. CPC B60T 8/885; B60T 13/74; B60T 17/221; B60T 2240/00; B60T 2270/402; B60T 2270/406; B60T 2270/408; B60T 2270/413

(57) ABSTRACT

A braking system for a motor vehicle has a first and a second parking brake A first and a second control device each have a driver for driving at least the first and/or the second parking brake actuator. The first control device has a first arbitration unit to data whether a parking brake action should be carried out. The second control device has a second arbitration unit to receive parking brake request data and to ascertain from the received data whether a parking brake action should be carried out. The result of the second arbitration unit is fed to the first arbitration unit as parking brake request data and the result of the first arbitration unit is transmitted to the driver of the first and/or second control device for driving the first and second parking brake actuators.

### CROSS-REFERENCE TO RELATED APPLICATIONS

The present application is a National Stage Application under 35 U.S.C. § 371 of International Patent Application No. PCT/DE2021/200026 filed on Mar. 1, 2021, and claims priority from German Patent Application No. 10 2020 202 919.9 filed on Mar. 6, 2020, in the German Patent and Trademark Office, the disclosures of which are herein incorporated by reference in their entireties.

### TECHNICAL FIELD

The invention relates to a braking system for a motor vehicle having a first parking brake actuator and a second parking brake actuator and a first control device and a second control device.

### BACKGROUND

Braking systems often have two control devices for a hydraulic service brake, wherein driving for building up pressure in the hydraulic service brake is implemented on the first control device during operation without faults and a stability program (ESC) is implemented on the second control device. In highly redundant systems, such as those required for autonomous driving, two separate control devices are likewise used, wherein all functions are implemented in a first control device and the second control device provides a reduced functionality in the event of a fault. A different distribution of functionalities amongst two control devices is also possible.

The two parking brake actuators are typically arranged on the wheels of one vehicle axle, for example the rear axle, and are driven either by the first control device or by the second control device.

According to the current state of the art, a transmission pawl which can hold the vehicle stationary in the long term is also used in addition to the parking brake. If a single component of the control device of the parking brake actuators fails, such as the microprocessor, the power supply or the driver, neither of the parking brake calipers is available any longer. However, the vehicle is still safely held stationary by the transmission pawl. However, the cost of such a transmission pawl is exceptionally high. Especially in the course of electrification of vehicles, transmissions are adapted to the requirements of the electric motors used, with it being possible to save significant costs in the entire combination by dispensing with the transmission pawl.

However, simply dispensing with the transmission pawl is not preferred for the above reasons since the vehicle could roll away in an uncontrolled manner if the parking brake calipers fail.

Therefore, providing a braking system which, without the provision of a transmission pawl, redundantly and therefore reliably preventing the vehicle from rolling away in an uncontrolled manner is not known.

### SUMMARY

A braking system, wherein a driver for driving at least a first and/or a second parking brake actuator is in each case provided on a first control device and a second control device. For example, the first driver of the first control device is designed at least to drive the first parking brake actuator and the second driver of the second control device is designed to drive the second parking brake actuator. The first and the second parking brake actuator are therefore connected in a driveable manner to the respective drivers of the associated control device or devices, and the driver is set up to drive the at least one parking brake actuator.

In this case, the first control unit can be set up to build up brake pressure of a hydraulic service brake when there are no faults. The second control unit can be set up to take over the driving for building up brake pressure of the hydraulic service brake when a fault occurs in the first control unit.

The first control device further has a first arbitration unit which is set up to receive first parking brake request data and to ascertain from the received parking brake request data whether a parking brake action should be carried out. Parking brake request data can be data that is important for applying and/or releasing the parking brake. Typical parking brake request data includes a signal from a parking brake switch, an external actuation signal, vehicle speed data from wheel speed sensors or from other sources, sensor data relating to door opening, the state of the vehicle key (e.g. key-out), ignition status, accelerator pedal position and many more.

The second control device has a second arbitration unit which is likewise set up to receive parking brake request data and to ascertain from the received parking brake request data whether a parking brake action should be carried out. This second parking brake request data from the second arbitration unit can be selected from the same group of data as the first parking brake request data, wherein the second parking brake request data from the second arbitration unit can be at least in part identical to or different from the first parking brake request data from the first arbitration unit. The result of the second arbitration unit is fed to the input end of the first arbitration unit as part of its parking brake request data, and the result of the first arbitration unit is transmitted to the driver of the first and/or the second control device for driving the first and the second parking brake actuator. Redundancy is established by splitting the driving of the first and the second parking brake actuators between two control devices. If one control device fails, at least one parking brake actuator is still operational and can prevent the motor vehicle from rolling away. Therefore, a transmission pawl is no longer necessary. Due to the independent arbitration units of the first and the second control device, which may be connected in series, a single decision point (single point of decision) is produced in spite of the split between the two control devices. In this way, control faults that can arise from contradictory driving are ruled out and the availability of the overall system is increased.

In an embodiment, a parking brake switch is provided, the switching state of which is fed to the first arbitration unit and/or the second arbitration unit as part of the first and/or the second parking brake request data. In order to supply the switching state to both arbitration units, the parking brake switch can be embodied as a double switch, for example. In this case, a mechanically actuable element is coupled internally to two electrical switches, which are each connected to an arbitration unit in order to supply a signal to the latter. The two internal electrical switches can be DC-isolated in this case.

In a further embodiment, the driver of the first control device is set up only to drive the first parking brake actuator and the driver of the second control device is set up only to drive the second parking brake actuator. In this case, the result of the first arbitration unit is transmitted to the driver of the first and the second control device for driving the first and the second parking brake actuator, so that both drivers can drive their correspondingly associated parking brake actuators in accordance with the result of the first arbitration unit. If one of the control devices fails, the ability of the parking brake actuator connected to the other control device to be adjusted therefore remains available. Since only one parking brake actuator is available, this leads to a reduced slope holding capability, but this is sufficient to meet the legal requirements and standards, and therefore a transmission pawl can also be dispensed with in this case. Therefore, only a minimal number of control lines is required.

In an alternative embodiment, the drivers of the first control device and the second control device are each set up to drive the first and the second parking brake actuator. Therefore, both parking brake actuators are driven by both control devices. Therefore, it is still possible to adjust the two parking brake actuators if one control device fails. This leads to full slope holding capability unless one of the parking brake actuators themselves has failed. Therefore, the vehicle can be held securely even on steep slopes, even in the event of a fault.

In a further embodiment, both control devices determine the state of the respectively associated parking brake actuators and transmit the determined state to the respective other control device. The states can include clamped, released, unknown or other states. The states of the two parking brake actuators can be combined to form an overall state, in particular in the first and/or the second control device. Therefore, the parking brake functions and any associated driver information messages can respond accordingly. For example, flashing warning lamps for faults or permanently lit indicator lights for successful application of both electronic brake calipers can be activated.

In a further embodiment, the first control device and the second control device are connected to one another via a separate communication line and/or via a vehicle bus, and the control devices are set up to communicate via this communication line. A separate communication line is independent of a vehicle bus in this case. This ensures that the two control devices can exchange all the information required for proper operation.

In another embodiment, the first control device and the second control device, in particular mutually, exchange availability information, wherein the second control device assumes that the first control device has failed if the availability information does not indicate availability and/or no availability information is received. Since the control devices therefore know about the availability of the respective other control device, they can react accordingly if one control device fails.

In another embodiment, the second arbitration unit is set up to transmit the result of the arbitration to the driver of the second control device for driving the at least one parking brake actuator if the first control device fails. If the second control device does not receive any availability information from the first control device or is informed by said first control device that the first control device is not available, the second control device drives the parking brake actuators connected there directly via its own driver. The second control device can therefore reliably drive at least one parking brake actuator even if the first control device fails completely. The second control device can be connected to an additional redundant switch, an alternative man/machine interface, such as an alternative switch that the driver can operate via the on-board computer for example, the data from which is supplied to the second arbitration unit as second parking brake request data. In addition, an automatic condition can be implemented in the arbitration unit, which, for example, applies the parking brake when the ignition is deactivated or releases the parking brake when driving off.

In another embodiment, at least one parking brake actuator is connected in a driveable manner to the first and the second control device. The first and the second control device are then set up to transfer the authorization to drive the parking brake actuator, which is connected in a driveable manner to the first and the second control device, by exchanging a token. The token can then be transferred as soon as a fault is established in the first control device, in the drive path or in one of the two parking brake actuators. The control device with the token drives the parking brake actuators as if it were the only control device in the combination. This prevents both control devices wanting to access a parking brake actuator at the same time and possibly making contradictory drive attempts in so doing.

In another embodiment, the first and/or the second control device is set up to drive the first parking brake actuator only when the control device itself has the token and the other control device does not have the token. This ensures that only one of the two control devices can be active at a time, while the other control device cannot perform any activity. For example, possible overlaps when transferring the token are therefore avoided since access can only take place as soon as the transfer of the token has been completed. This prevents a short circuit from occurring, for example, when a command to apply the parking brake (apply request) is made by the first control device and at the same time a command to release it (release request) is made by the second control device.

In another embodiment, during a switch-on process, for example start-up of the control devices after switching on the ignition of the motor vehicle, the first or the second control device receives the token which authorizes driving of the parking brake actuator which is connected in a driveable manner to the first and the second control device. Accordingly, the other control device does not receive a token. Therefore, it is clearly defined right from the start which of the control devices is allowed to access the parking brake actuators.

In another embodiment, four wheel speed sensors are provided, which are each associated with one of four wheels of the motor vehicle, wherein the first or the second control device receives data from all four wheel speed sensors and the other control device receives data from only two wheel speed sensors. The wheel speed sensors can be used to determine whether the motor vehicle is stationary, in order to apply the parking brake only when the vehicle is stationary. This prevents incorrect activation of the parking brakes while driving. Owing to the redundant control of the parking brakes, it is sufficient if only two of the four speed sensors are available for the second control device since determining whether the vehicle is stationary by means of two wheel speed sensors is sufficient for the rare situation of a control device failing.

In another embodiment, a multiplexer for the data from two wheel speed sensors is provided for this purpose, which multiplexer, if there is no fault, feeds the data from the two wheel speed sensors to the control device that receives data from all four wheel speed sensors and, only if this control device fails, supplies the data from the two wheel speed sensors to the control device that receives data from only two wheel speed sensors. Therefore, the control device that is responsible for driving the parking brake actuators always has at least information about two wheel speed sensors, so that the situation of the vehicle being stationary can be verified.

In a further embodiment, the two wheel speed sensors of the multiplexer are associated with wheels arranged diagonally in relation to one another. By distributing the checked wheels in this way, the situation of the vehicle being stationary can be proven reliably.

A method for controlling a braking system, with two parking brake actuators and two control devices, comprises a first arbitration unit of the first control device receiving first parking brake request data and ascertaining from the received first parking brake request data whether a parking brake action should be carried out. A second arbitration unit of the second control device receives parking brake request data and ascertains from the received second parking brake request data whether a parking brake action should be carried out. The result of the second arbitration unit is fed to the input end of the first arbitration unit as first parking brake request data. The result of the first arbitration unit is transmitted to a driver of the first and/or the second control device for driving the parking brake actuators.

. Other objects, features and characteristics, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the embodiments of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a schematic illustration of a first embodiment;

FIG. 2 shows a schematic illustration of a second;

FIG. 3 shows a schematic illustration of the communication paths of the embodiment of FIG. 1 and FIG. 2,

FIG. 4 shows a diagram of a token exchange;

FIG. 5 shows the distribution of the wheel speed sensor signals of one embodiment;

FIG. 6 shows the distribution of the wheel speed sensor signals of a further embodiment.

### DETAILED DESCRIPTION

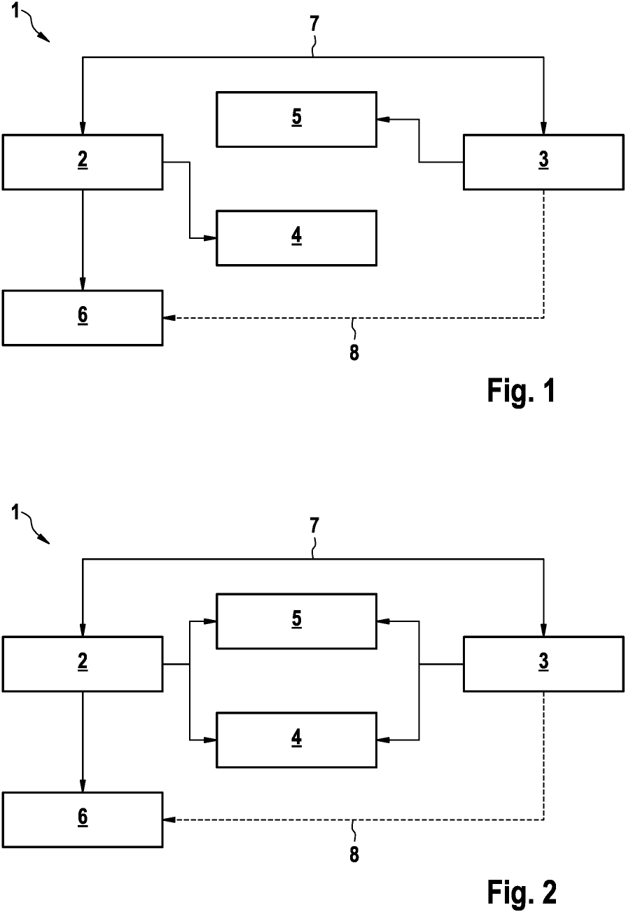

In the embodiment of the invention illustrated in FIG. 1, a first control device 2 is embodied as the main control device (main ECU), which takes over driving of a hydraulic brake unit 6 which is designed as a service brake of a motor vehicle. For example, the first control device 2 can issue commands for building up pressure in the hydraulic brake unit 6. Furthermore, the first control device 2 is set up to drive a first electronic parking brake (EPB) with a corresponding parking brake actuator 4 and is connected to said parking brake. The first control device 2 has no direct connection to the second electronic parking brake in order to drive it.

The second control device 3 (secondary ECU) is set up to drive a second electronic parking brake with the corresponding parking brake actuator 5 and is connected to said parking brake. The second control device 3 has no direct connection to the first electronic parking brake in order to drive it.

Furthermore, the second control device 3 has a redundant hydraulic controller 8 by way of which the hydraulic brake device 6 can be driven if the first control unit 2 fails. During operation without faults, the redundant hydraulic controller 8 is inactive.

A communication line 7 connects the first control device 2 and the second control device 3 in order to guarantee reliable communication between the two control devices 2, 3.

Therefore, if one of the control devices 2, 3 fails, at least one of the two electronic parking brake actuators 4, 5 can always be driven. This ensures at least a slight slope holding capability.

FIG. 2 shows an alternative embodiment. Identical components are provided with the same reference symbols as in the first embodiment of FIG. 1. The first control device 2, which is set up to control the hydraulic brake unit 6, is set up to drive both parking brakes with the associated parking brake actuators 4, 5 and is connected to them in a driveable manner. The second control device 3 is also connected to the two electronic parking brakes with the associated parking brake actuators 4, 5 and is set up to drive the two parking brake actuators 4, 5. A communication line 7 is also provided in this embodiment, which enables the exchange of information between the first control device 2 and the second control device 3. The communication line 7 is embodied as a separate communication line 7, but can also be embodied as a vehicle bus, for example. For reasons of redundancy, the second control device 3 is in turn suitable for driving 8 the hydraulic brake unit 6. In this embodiment, even if one of the two control devices 2, 3 fails, both parking brake actuators 4, 5 are fully operational, and therefore a full slope holding capability can be provided.

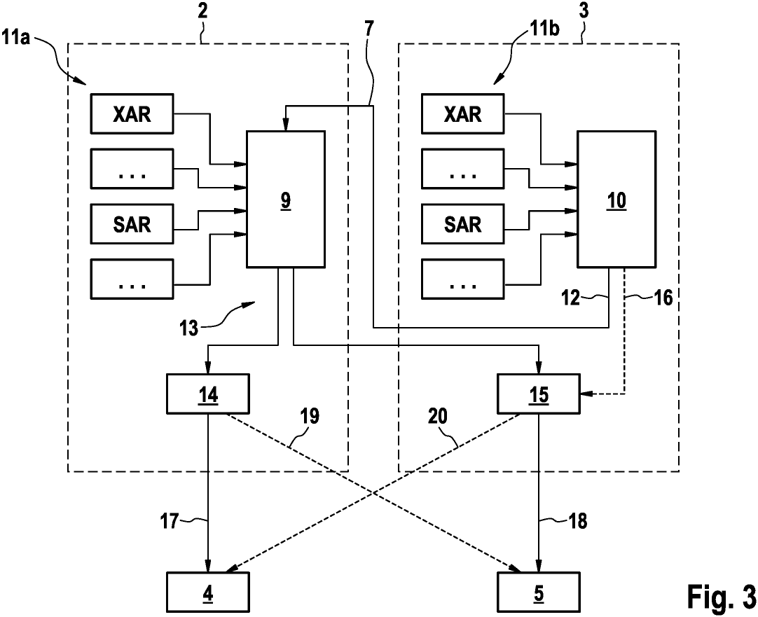

FIG. 3 schematically shows the structure of the two control devices 2, 3 and the corresponding communication paths.

A second arbitration unit 10 is provided in the second control device 3, which, based on the parking brake request data 11b made available, ascertains whether an EPB request (electronic parking brake request) is required, that is to say whether driving of the parking brake actuators 4, 5 is required. At least the signal of a parking brake switch (SAR - static apply release) and a possible external parking brake command (XAR - external apply release) are fed to the second arbitration unit 10 as parking brake request data 11b. The result of the second arbitration 12 is transmitted via the communication line 7 to the first control device 2, and fed there to the first arbitration unit 9 as part of its parking brake request data 11a.

Furthermore, at least the signal from a parking brake switch (SAR) and a possible external parking brake command (XAR) are also fed to the first arbitration unit 9 as parking brake request data 11a. However, it is also possible to feed the signal from the parking brake switch and/or a possible external parking brake command to only one of the two arbitration units 9, 10 since in this case too, due to the cascading of the two arbitration units 9, 10, all parking brake request data 11 is taken into consideration in any case. The first arbitration unit 9 uses all of the parking brake request data 11a, including the result 12 of the second arbitration, to ascertain whether an EPB request is required. This result is transmitted to the first driver 14 of the first control device 2, which first driver forms a mechatronic subsystem for driving parking brake actuators. The result is also transmitted to the second driver 15 of the second control device 3, which second driver likewise forms a mechatronic subsystem for driving parking brake actuators.

In the first embodiment of FIG. 1, the first driver 14 is connected to the first parking brake actuator 4 only via a control line 17 and the second driver 15 is connected to the second parking brake actuator 5 only via a control line 18. The cross-connections 19, 20 do not exist in this embodiment.

The ascertained EPB request is therefore executed on both electronic parking brake actuators 4, 5.

If a fault occurs in one of the two control devices 2, 3, the system remains at least partially functional. In the event of a total failure of the second control device 3, the first control device 2 does not receive any result 12 from the second arbitration unit 10 via the communication line 7. However, the first arbitration unit 9 can carry out an arbitration based on the remaining parking brake request data 11a. In this case too, the result 13 of the arbitration can be transmitted at least to the driver 14 for driving the first parking brake actuator 4.

If, on the other hand, the first control device 2 fails, the first control device 2 communicates this to the second control device 3 via the communication line 7. This can take place either by way of explicit notification or by way of not sending availability information. The second control device 3 assumes that the first control device 2 has failed if it does not receive any availability information from the first control device 2 via the communication line 7. In this case, the second control device 3 likewise carries out an arbitration in the second arbitration unit 10 based on the parking brake request data 11b but does not transmit this result 12 of the arbitration to the first control device 2, but rather passes the result directly to the driver 15 as redundant parking brake driving 16. The driver 15 can then drive at least the second parking brake actuator 5 via the control line 18. In this case too, at least a reduced slope holding capability is ensured.

In the embodiment of FIG. 2, the first control device 2 with the first driver 14 is additionally connected to the second electronic parking brake and the associated parking brake actuator 5 via a control line 19. The second control device 3, with its driver 15, is additionally connected to the first parking brake actuator 4 via a control line 20. Therefore, each parking brake actuator 4, 5 can be driven by both control devices 2, 3, and therefore both parking brake actuators 4, 5 are available even if one of the two control devices 4, 5 fails.

In order to prevent a parking brake actuator 4, 5 from being driven simultaneously by two drivers 14, 15, in particular being driven in a contradictory manner, provision is made for only one of the two control devices 2, 3 to receive authorization to actually drive the electronic parking brake actuators 4, 5. In the case of contradictory driving, a parking brake actuator 4, 5 would otherwise be driven via the first driver 14 with a first polarity and via the second driver 15 with the opposite polarity. This would directly connect the two poles of the power supply to one another, as a result of which a short circuit would be created. Such a short circuit could damage both control devices at the same time and thereby lead to double failure. The authorization is realized by an exchangeable token here.

In this case, the token can already be checked at the output of the first arbitration unit 9, and the first arbitration unit 9 can only transmit the result 13 of the arbitration to the first driver 14 if the first control device 2 itself has the token. If, on the other hand, the second control device 3 has the token, the first arbitration unit 9 can transmit the result of the arbitration 13 only to the second driver 15 of the second control device 3. As an alternative, the result 13 of the arbitration can always be transmitted by the arbitration unit 9 to both drivers 14, 15 of the first control device 2 and, respectively, the second control device 3. A check as to whether its own control device has the token then only takes place in the driver 14, 15 itself. The driver 14, 15 correspondingly drives the parking brake actuators 4, 5 via the control line 17, 18, 19, 20 only when its own control device has the token.

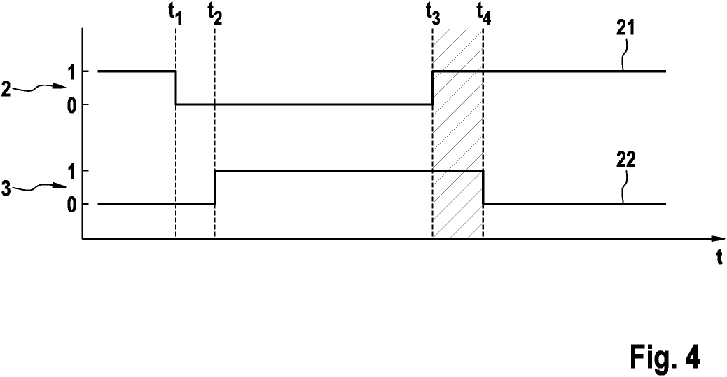

FIG. 4 shows, by way of example, the transfer of the token using a timing diagram. A token status 21, 22 is implemented as a binary variable, which indicates whether the respective control device has the token, both in the first control device 2 and in the second control device 3. Accordingly, the token status 21, 22 can only assume the values ‘0’ or ‘1’. At the beginning until time t₁, the first control device 2 has the token and the token status 21 accordingly has the value ‘1’. The second control device 3 does not have a token and the token status 22 therefore has the value ‘0’. At a time t₁, the first control device 2 establishes a fault and therefore transfers the token to the second control device 3. To do this, the first control device 2 sets its own token status 21 to ‘0’ and sends a corresponding message to the second control device 3 via the communication line 7. At a time t₂, the second control device 3 receives the corresponding message via the communication line 7 and sets its own token status to ‘1’.

At a time t₃, the first control device 2 establishes that it is functioning without faults again and acquires the token. The first control device 2 therefore sets its own token status 21 to ‘1’ and sends a corresponding message to the second control device 3 via the communication channel 7. At a time t₄, the second control device 3 receives the corresponding message and sets its own token status 22 to ‘0’. Between time t₃ and t₄, both the token status 21 of the first control device 2 and the token status 22 of the second control device 3 have the value ‘1’ for a short period of time. In order to avoid double access to the parking brake actuators 4, 5 during this period, a driver 14, 15 can only access the parking brake actuators 4, 5 if its own control device 2, 3 has the token, i.e. the token status 21, 22 has the value ‘1’ and the token status 21, 22 of the respective other control device 2, 3 has the value ‘0’. Therefore, neither of the drivers can access the parking brake actuators 4, 5 in the period between t₃ and t₄.

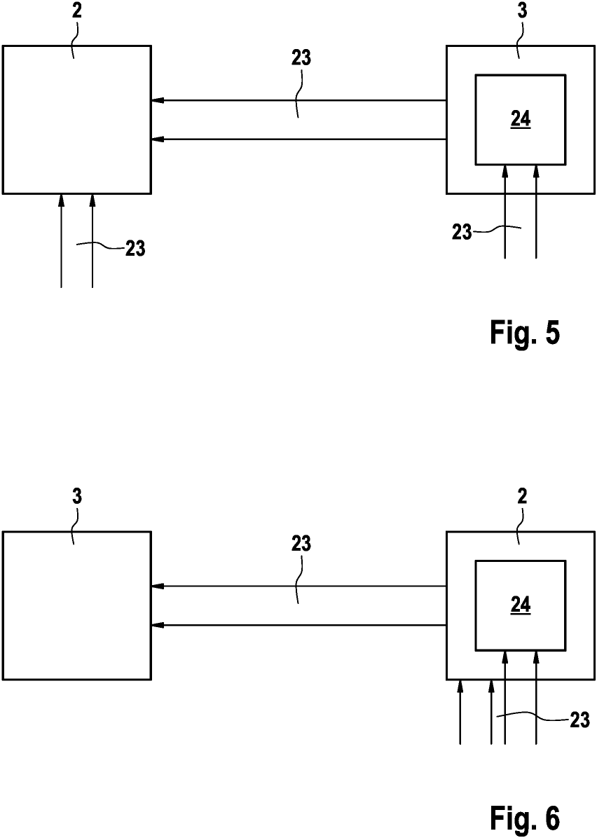

In order to prevent parking brake actuators from being activated when the vehicle is moving and thereby causing a dangerous situation, a check is made as to whether the vehicle is stationary before the parking brake actuators 4, 5 are applied. Wheel speed sensor data 23 is used for this purpose. Two items of wheel speed sensor data 23 are distributed via a multiplexer 24 in order to be able to establish that the vehicle is stationary both in the first control device and in the second control device 3. A corresponding architecture is illustrated in FIG. 5, in which the wheel speed sensor data from two wheels of the vehicle is transmitted directly to the first control device 2 and the wheel speed sensor data 23 from the other two wheels of the vehicle is transmitted directly to the second control device 3. The second control device 3 has a multiplexer 24 which can either transmit the signal from the two wheel speed sensors to the corresponding computer unit of the second control device 3 or communicates it to the first control device 2. For this purpose, the multiplexer 24 can have a direct (hard-wired) connection to the first control device 2. The signals from the wheel speed sensors are then applied to the first control device 2 as if the wheel speed sensors were connected directly to the first control device 2. The multiplexer 24 is designed in such a way that it passes the wheel speed data to the other control device 2, 3 with no current flowing, that is to say when its own control device 2, 3 has a defect.

An alternative embodiment is illustrated in FIG. 6, in which the wheel speed signals from all four wheels initially arrive at the first control device 2. Two wheel speed sensors are in turn passed to the second control device 2 via the multiplexer 24.

In both variants, if there are no faults, all four items of wheel speed sensor data are made available to the first control device 2 since this carries out the actual driving of the parking brake actuators 4, 5 if there are no faults. In the rare case of a fault occurring, the second control device 3 has two more items of wheel speed sensor data 23 available in order to establish that the vehicle is stationary.

The braking system ensures that even if one of the control devices fails, at least a reduced slope holding capability is available, so that a transmission pawl is no longer necessary and can therefore be dispensed with. This ensures that there is always a “single point of decision” in order to rule out possible control errors.

1. A braking system for a motor vehicle comprising:
a first parking brake actuator and a second parking brake actuator;
a first control device and a second control devicewhich each have a driver for driving at least the first and/or the second parking brake actuator;
a first arbitration unitof the first control unit which is set up to receive first parking brake request data and to ascertain from the received first parking brake request data whether a parking brake action should be carried out;
a second arbitration unitof the second control unit which is set up to receive second parking brake request data and to ascertain from the received second parking brake request data whether a parking brake action should be carried out,
wherein a result of the second arbitration unitis fed to the input end of the first arbitration unitas part of the first parking brake request data; and
wherein a result of the first arbitration unit is transmitted to the driver of at least one of the first and the second control device for driving the first and the second parking brake actuators.

2. The braking system as claimed in claim 1, further comprising a parking brake switch, wherein a switching state of the parking brake switch is fed to at least one of the first arbitration unit and the second arbitration unit as part of the at least one first and the second parking brake request data.

3. The braking system as claimed in claim 1, wherein the driverof the first control device is set up only to drive the first parking brake actuatorand the driver of the second control deviceis set up only to drive the second parking brake actuator.

4. The braking system as claimed in claim 1, wherein the drivers of the first control device and the second control device are each set up to drive the first and the second parking brake actuator.

5. The braking system as claimed in claim 1, wherein both control devices determine the state of the respectively associated parking brake actuators and transmit the determined state to the respective other control device .

6. The braking system as claimed in claim 1, wherein the first control deviceand the second control devicecommunicate with one another via one of a separate communication line and a vehicle bus.

7. The braking system as claimed in claim 1, wherein the first control device and the second control device exchange availability information , wherein the second control device assumes that the first control device has failed when one of the availability information does not indicate and no availability information is received.

8. The braking system as claimed in claim 1, wherein the second arbitration unit is set up to transmit the result of the arbitration to the driver of the second control devicefor driving the at least one parking brake actuatorif the first control device fails.

9. The braking system as claimed claim 1, wherein at least one of the parking brake actuator is connected in a driveable manner to the first and the second control device,wherein the first and the second control device are set up to transfer the authorization to drive the parking brake actuator that is connected in a driveable manner to the first and the second control device by exchanging a token.

10. The braking system as claimed in claim 9, wherein during a switch-on process one of the the first and the second control device receives the token which authorizes driving of the parking brake actuator that is connected in a driveable manner to the first and the second control device , and the other control device does not receive a token.

11. The braking system as claimed in claim 9, wherein at least one of the first and the second control device is set up to drive the parking brake actuator only when the control device itself has the token and the other control device does not have the token.

12. The braking system as claimed in claim 1, further comprising four wheel speed sensors which are each associated with one of four wheels of the motor vehicle, wherein one of the first and the second control device receives data from all four wheel speed sensors and the other control device receives data from only two wheel speed sensors.

13. The braking system as claimed in claim 12, further comprising a multiplexer for the data from two wheel speed sensors, wherein when there is no fault the multiplexer feeds the data from the two wheel speed sensors to the control device that receives data from all four wheel speed sensors and, only if this control device fails, supplies the data from the two wheel speed sensors to the control device that receives data from only two wheel speed sensors.

14. The braking system as claimed in claim 13, wherein the two wheel speed sensors of the multiplexer are associated with wheels arranged diagonally in relation to one another.

15. (canceled)

16. The braking system as claimed in claim 5, wherein in at least one of the first and the second control device, the states of the two parking brake actuators are combined to form an overall state.

17. The braking system as claimed in claim 7, wherein the exchange availability information is mutual.

18. A method for controlling a braking system with two parking brake actuators and two control devices comprising:
receiving first parking brake request data with a first arbitration unit of the first control device;
ascertaining from the received first parking brake request data whether a parking brake action should be carried out;
receiving second parking brake request data with a second arbitration unit of the second control device;
ascertaining from the received second parking brake request data whether a different parking brake action should be carried out;
feeding a result of the second arbitration unit to the input end of the first arbitration unit as part of the first parking brake request data; and
transmitting a result of the first arbitration unit to a driver of at least one of the first and the second control device for driving the first and the second parking brake actuator.
